(19) United States
(12) Patent Application Publication
(10) Pub. No.: US 2026/0142380 A1
(43) Pub. Date: May 21, 2026

(54) LIQUID CRYSTAL COMPOSITION FOR RADIO WAVE CONTROL ELEMENT, AND RADIO WAVE CONTROL ELEMENT

(71) Applicant: FUJIFILM Corporation, Tokyo (JP)

(72) Inventors: Ryoji GOTO, Minamiashigara-shi (JP); Yukito SAITOH, Minamiashigara-shi (JP); Taketo OTANI, Minamiashigara-shi (JP); Hideki YASUDA, Minamiashigara-shi (JP)

(73) Assignee: FUJIFILM Corporation, Tokyo (JP)

(21) Appl. No.: 19/359,784

(22) Filed: Oct. 16, 2025

Related U.S. Application Data
(63) Continuation of application No. PCT/JP2024/018254, filed on May 17, 2024.

(30) Foreign Application Priority Data
May 19, 2023 (JP) 2023-083296

(51) Int. Cl. H01Q 15/00; C09K 19/16; C09K 19/60; H01Q 1/02; H01Q 15/02

(52) U.S. Cl. CPC H01Q 15/0086; C09K 19/16; C09K 19/601; H01Q 1/02; H01Q 15/002; H01Q 15/02

(57) ABSTRACT

A liquid crystal composition for a radio wave control element is provided. The composition serves as a material exhibiting a large refractive index anisotropy with respect to radio waves. The composition includes at least one dichroic coloring agent, with a total content of 30% by mass or more relative to the total mass of the liquid crystal composition. The liquid crystal composition exhibits high absorbance in the wavelength range of 350 to 1,000 nm, making it suitable for use in radio wave control elements requiring strong optical anisotropy and efficient absorption characteristics.

### CROSS-REFERENCE TO RELATED APPLICATIONS

This application is a Continuation of PCT International Application No. PCT/JP2024/018254 filed on May 17, 2024, which claims priority under 35 U.S.C. § 119 (a) to Japanese Patent Application No. 2023-083296 filed on May 19, 2023. The above applications are hereby expressly incorporated by reference, in their entirety, into the present application.

### BACKGROUND OF THE INVENTION

### 1. Field of the Invention

The present invention relates to a liquid crystal composition for a radio wave control element, and a radio wave control element.

### 2. Description of the Related Art

Radio waves such as high-frequency radio waves (millimeter waves, terahertz waves) required for high-capacity wireless communication have high straightness. Therefore, a radio wave control element that bends the traveling direction of the radio waves in any directions is required.

However, for example, in a normal reflector, the reflection directions of the radio waves are constant, and the reflection directions are specular reflections where the incidence angle and the emission angle are equal. Therefore, the reflector had a problem in that there is a significant restriction on a range in which the traveling directions of the radio waves are changed and it is difficult to deliver the radio waves to desired places.

JP7101619B discloses a radio wave control element using a liquid crystal medium, and discloses a predetermined polychromatic compound as the liquid crystal medium.

### SUMMARY OF THE INVENTION

On the other hand, with regard to the radio wave control element using a liquid crystal medium, it has been desired to reduce the thickness and shorten the driving time. In order to obtain a radio wave control element exhibiting such characteristics, a liquid crystal medium having a larger refractive index anisotropy (Δn) was required.

The present inventors have evaluated the characteristics of the liquid crystal medium described in JP7101619B, and have found that the characteristics do not satisfy the required characteristics in recent years and further improvement is required.

In view of the circumstances, an object of the present invention is to provide a liquid crystal composition for a radio wave control element, which can serve as a material having a large refractive index anisotropy with respect to radio waves.

In addition, another object of the present invention is to provide a radio wave control element.

The present inventors have conducted intensive studies to achieve the objects, and as a result, have found that the objects can be achieved by the following configurations.

(1) A liquid crystal composition for a radio wave control element, the liquid crystal composition including:
at least one dichroic coloring agent,
in which a total content of the dichroic coloring agent is 30% by mass or more with respect to a total mass of the liquid crystal composition for a radio wave control element, and
an integrating accumulate absorbance Q represented by Expression (1) described later in a wavelength range of 350 to 1,000 nm in an absorption spectrum of a chloroform solution of the liquid crystal composition for a radio wave control element is 10,000 L·g⁻¹·cm⁻¹ or more.

(2) The liquid crystal composition for a radio wave control element according to (1),
in which the liquid crystal composition for a radio wave control element includes two or more dichroic coloring agents.

(3) The liquid crystal composition for a radio wave control element according to (1) or (2),
in which the dichroic coloring agent is a compound represented by Formula (X) described later.

(4) The liquid crystal composition for a radio wave control element according to any one of (1) to (3),
in which the liquid crystal composition for a radio wave control element exhibits a nematic phase in an entire range of 10° C. to 50° C.

(5) The liquid crystal composition for a radio wave control element according to any one of (1) to (4),
in which the liquid crystal composition for a radio wave control element exhibits a nematic phase at any temperature between 50° C. and 150° C., and exhibits a glassy state or smectic phase at any temperature lower than 50° C.

(6) A radio wave control element including, in the following order:
a first electrode;
a liquid crystal composition layer consisting of the liquid crystal composition for a radio wave control element according to any one of (1) to (5); and
a second electrode.

(7) The radio wave control element according to (6),
in which the radio wave control element has a metasurface structure obtained by arranging a plurality of microstructures, and
the microstructure constitutes at least one of the first electrode or the second electrode.

(8) The radio wave control element according to (6) or (7), further including:
a temperature adjusting member that adjusts a temperature of the liquid crystal composition layer.

(9) The radio wave control element according to any one of (6) to (8),
in which the radio wave control element has a layer having no occurrence of a change in refractive index due to a voltage between the first electrode and the second electrode, or a gap between one of the first electrode and the second electrode and the liquid crystal composition layer.

(10) The radio wave control element according to any one of (6) to (9), further including:
a light shielding layer that shields at least a part of light in a wavelength range of 250 to 1,000 nm.

According to the present invention, it is possible to provide a liquid crystal composition for a radio wave control element, which can serve as a material having a large refractive index anisotropy with respect to radio waves.

In addition, according to the present invention, it is possible to provide a radio wave control element.

### BRIEF DESCRIPTION OF THE DRAWINGS

FIG. 1 is a view showing a use example of a radio wave control element.

FIG. 2 is a view showing an example of a metasurface structure used in a radio wave control element.

FIG. 3 is a view showing a mechanism by which an emission direction of radio waves is changed in a radio wave control element.

FIG. 4 is a view conceptually showing an example of a radio wave control element.

FIG. 5 is a view conceptually showing an example of a liquid crystal alignment pattern in a radio wave control element.

FIG. 6 is a view showing a relationship between an applied voltage and a delay amount of a phase of a radio wave.

FIG. 7 is a view conceptually showing another example of the radio wave control element.

FIG. 8 is a view conceptually showing yet another example of the radio wave control element.

FIG. 9 is a view conceptually showing yet another example of the radio wave control element.

FIG. 10 is a view conceptually showing yet another example of the radio wave control element.

FIG. 11 is a view conceptually showing yet another example of the radio wave control element.

### DESCRIPTION OF THE PREFERRED EMBODIMENTS

Hereinafter, the present invention will be described in detail.

Descriptions of the constitutional requirements described later are made based on representative embodiments of the present invention in some cases, but it should not be construed that the present invention is limited to such embodiments.

Furthermore, in the present specification, a numerical range expressed using “to” means a range that includes the preceding and succeeding numerical values of “to” as the lower limit value and the upper limit value, respectively.

In addition, in the present specification, the terms parallel and orthogonal do not respectively indicate parallel and orthogonal in a strict sense, but respectively indicate a range of parallel ±5° and a range of orthogonal ±5°.

In addition, in the present specification, for each component, substances corresponding to each component may be used alone or in combination of two or more kinds thereof. Here, in a case where the two or more kinds of the substances are used in combination for each component, the content of the component refers to a total content of the substances used in combination unless otherwise specified.

In the present specification, the bonding direction of a divalent group (for example, —CO—O—) as described is not limited unless otherwise specified. For example, in a case where Y in a compound represented by Formula “X—Y—Z” is —CO—O—, the compound may be any of “X—O—CO—Z” or “X—CO—O—Z”.

The liquid crystal composition for a radio wave control element of the embodiment of the present invention (hereinafter also simply referred to as “the present composition”) includes at least one dichroic coloring agent, in which a total content of the dichroic coloring agent is 30% by mass or more with respect to a total mass of the liquid crystal composition for a radio wave control element, and an integrating accumulate absorbance Q represented by Expression (1) described later in a wavelength range of 350 to 1,000 nm in an absorption spectrum of a chloroform solution of the liquid crystal composition for a radio wave control element is 10,000 L·g⁻¹·cm⁻¹ or more.

Hereinafter, the integrating accumulate absorbance Q, which is a feature point of the present composition, will be described in detail, and then the components included in the present composition will be described in detail.

The integrating accumulate absorbance Q represented by Expression (1) described later in a wavelength range of 350 to 1,000 nm in an absorption spectrum of a chloroform solution of the present composition is 10,000 L·g⁻¹·cm⁻¹ or more.

In a case where the integrating accumulate absorbance Q is 10,000 L·g⁻¹·cm⁻¹ or more, the present composition can serve as a material having a large refractive index anisotropy with respect to radio waves. More specifically, as described later, the refractive index anisotropy with respect to radio waves can be increased by aligning the dichroic coloring agents in the present composition.

Furthermore, the radio waves mean electromagnetic waves having a frequency of 0.007 to 0.3 THz, and having strong straightness due to a high frequency.

The integrating accumulate absorbance Q is an index that represents the light absorption characteristics of the present composition in a wavelength range of 350 to 1,000 nm, and a high numerical value of the integrating accumulate absorbance Q means that the absorption characteristics are excellent. It is known that the refractive index of a substance is related to the light absorption characteristics, and the present inventors have found that the refractive index anisotropy with respect to radio waves is significantly increased by adjusting the integrating accumulate absorbance Q of the present composition to be within a predetermined range. In particular, it has been found that by improving the absorption characteristics in a wavelength range of 350 to 1,000 nm, the refractive index in the radio wave region can be increased, and as a result, the refractive index anisotropy with respect to radio waves can be increased.

Among those, from the viewpoint that the refractive index anisotropy of a material obtained using the present composition can be further increased (hereinafter also simply referred to as “the viewpoint that the effect of the present invention is more excellent”), the integrating accumulate absorbance Q is preferably 11,000 L·g⁻¹·cm⁻¹ or more, more preferably 12,000 L·g⁻¹·cm⁻¹ or more, still more preferably 13,000 L·g⁻¹·cm⁻¹ or more, and particularly preferably 15,000 L·g⁻¹·cm⁻¹ or more.

The upper limit of the integrating accumulate absorbance Q is not particularly limited, but is often 50,000 L·g⁻¹·cm⁻¹ or less, more often 40,000 L·g⁻¹·cm⁻¹ or less, and still often 30,000 L·g⁻¹·cm⁻¹ or less.

The integrating accumulate absorbance Q is calculated by Expression (1).

$$Q = \frac{1}{D \cdot L} {\int }_{350}^{1000} Abs ( λ ) d λ \qquad Expression ( 1 )$$

In Expression (1), Q represents an integrating accumulate absorbance (L·g⁻¹·cm⁻¹), D represents a mass concentration (g·L⁻¹) of the liquid crystal composition for a radio wave control element in the chloroform solution, L represents an optical path length (cm) of a cell used for measuring the absorption spectrum, and Abs (λ) represents an absorbance at a wavelength λ (nm). Furthermore, the definite integral in Expression (1) represents a value determined by numerically integrating an absorbance measured at an interval of 1 nm in a wavelength range of 350 to 1,000 nm.

In the measurement of the integrating accumulate absorbance Q, a commercially available device can be used, and examples thereof include a spectrophotometer UV-3100PC manufactured by Shimadzu Corporation. In the measurement of the integrating accumulate absorbance Q, a cell having a predetermined optical path length is filled with a chloroform solution, in which a predetermined amount of the liquid crystal composition for a radio wave control element is dissolved, to perform the measurement.

### <Dichroic Coloring Agent>

The dichroic coloring agent is a substance exhibiting dichroism, and the dichroism means a property in which an absorbance varies depending on a polarization direction.

The “dichroic coloring agent” in the present invention preferably has an absorption maximum wavelength in a range of 350 to 1,000 nm.

As the dichroic coloring agent, an appropriate and optimum type of dichroic coloring agent is selected to satisfy the range of the integrating accumulate absorbance Q.

The dichroic coloring agent may be used alone or in combination of two or more kinds thereof. Among these, the present composition preferably includes two or more dichroic coloring agents. In a case where the present composition includes two or more dichroic coloring agents, the present composition preferably includes two to four dichroic coloring agents, and more preferably includes two or three dichroic coloring agents.

The dichroic coloring agent preferably exhibits liquid crystallinity. That is, a liquid crystalline dichroic coloring agent is preferable.

Furthermore, the expression “exhibiting liquid crystallinity” is intended to mean that the compound has a property of exhibiting a liquid crystal phase (mesophase) between a crystal phase (low temperature side) and an isotropic phase (high temperature side) in a case where the temperature is changed. As a specific observation method, the optical anisotropy and the fluidity derived from the liquid crystal phase can be confirmed by observing the compound under a polarizing microscope while heating or cooling the compound.

Among these, from the viewpoint that the effect of the present invention is more excellent, the compound represented by Formula (X) is preferable as the dichroic coloring agent.

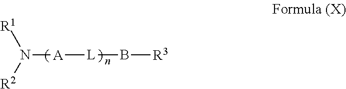

In Formula (X), R¹ and R² each independently represent a linear or branched hydrocarbon group having 1 to 10 carbon atoms, and the hydrocarbon group may include an oxygen atom, a nitrogen atom, or a sulfur atom.

The hydrocarbon group has 1 to 10 carbon atoms, and from the viewpoint that the effect of the present invention is more excellent, the hydrocarbon group preferably has 1 to 8 carbon atoms, and more preferably has 2 to 6 carbon atoms.

The hydrocarbon group is linear or branched, and is preferably linear.

The hydrocarbon may be a saturated hydrocarbon group or an unsaturated hydrocarbon group.

The hydrocarbon group may include an oxygen atom, a nitrogen atom, or a sulfur atom. The hydrocarbon group may include a plurality of atoms selected from the group consisting of an oxygen atom, a nitrogen atom, and a sulfur atom.

For example, the hydrocarbon group may include —O—, —S—, —CO—, —CS—, —CO—O—, —CO—NR¹⁰—, —NR¹⁰—, or a group obtained by combining these at a carbon-carbon atom or a terminal.

R¹⁰ represents a hydrogen atom or an alkyl group.

As the hydrocarbon group, an alkyl group, which may include —O—, —S—, —CO—, CS—, —CO—O—, —CO—NR¹⁰—, —NR¹⁰—, or a group obtained by combining these groups, at a carbon-carbon atom or a terminal, is preferable.

R¹ and R² may be bonded to each other to form a ring.

The ring to be formed may be an aliphatic ring or an aromatic ring.

A and B each independently represent a divalent aromatic ring group.

Examples of the divalent aromatic ring group include a divalent aromatic hydrocarbon ring group and a divalent aromatic heterocyclic group.

The divalent aromatic hydrocarbon ring group is a group obtained by removing two hydrogen atoms from an aromatic hydrocarbon ring. The aromatic hydrocarbon ring may be a monocyclic ring or a fused ring. Examples of the aromatic hydrocarbon ring include a benzene ring, a naphthalene ring, an anthracene ring, a pyrene ring, a phenanthrene ring, and a fluorene ring.

The divalent aromatic heterocyclic group is a group obtained by removing two hydrogen atoms from an aromatic heterocyclic ring. The aromatic heterocyclic ring may be a monocyclic ring or a fused ring. Examples of the aromatic heterocyclic ring include a pyridine ring, a pyrimidine ring, a pyridazine ring, a pyrazine ring, a triazine ring (for example, a 1,2,3-triazine ring, a 1,2,4-triazine ring, and a 1,3,5-triazine ring), a tetrazine ring (for example, a 1,2,4,5-tetrazine ring), a quinoxaline ring, a pyrrole ring, a furan ring, a thiophene ring, an imidazole ring, an oxazole ring, a thiazole ring, a benzopyrrole ring, a benzofuran ring, a benzothiophene ring, a benzimidazole ring, a benzoxazole ring, a benzothiazole ring, a naphthopyrrole ring, a naphthofuran ring, a naphthothiophene ring, a naphthimidazole ring, a naphthoxazole ring, a pyrroloimidazole ring (for example, a 5H-pyrrolo[1,2-a]imidazole ring), an imidazooxazole ring (for example, an imidazo[2,1-b]oxazole ring), a thienothiazole ring (for example, a thieno[2,3-d]thiazole ring), a benzothiadiazole ring, a benzodithiophene ring (for example, a benzo[1,2-b: 4,5-b′]dithiophene ring), a thienothiophene ring (for example, a thieno[3,2-b]thiophene ring), a thiazolothiazole ring (for example, a thiazolo[5,4-d]thiazole ring), a naphthodithiophene ring (for example, a naphtho[2,3-b:6,7-b′]dithiophene ring, a naphtho[2,1-b:6,5-b′]dithiophene ring, a naphtho[1,2-b:5,6-b′]dithiophene ring, and a 1,8-dithiadicyclopenta[b,g]naphthalene ring), a benzothienobenzothiophene ring, a dithieno[3,2-b:2′,3′-d]thiophene ring, and a 3,4,7,8-tetrathiadicyclopenta[a, e]pentalene ring. L represents a single bond, —CR═CR—, —C≡C—, —CR═N—, or —N═N—.

R's each independently represent a hydrogen atom, a halogen atom, or an alkyl group having 1 to 6 carbon atoms.

n represents an integer of 1 to 3, and in a case where n is 2 or 3, a plurality of A's and L's may be the same as or different from each other.

R³ represents a hydrogen atom or a substituent.

The type of the substituent is not particularly limited, and examples thereof include a halogen atom (for example, a fluorine atom, a chlorine atom, a bromine atom, and an iodine atom), a hydrocarbon group (an alkyl group (including a cycloalkyl group, a bicycloalkyl group, and a tricycloalkyl group), an alkenyl group (including a cycloalkenyl group and a bicycloalkenyl group), an alkynyl group, an aryl group, and the like), a heterocyclic group, a cyano group, an isothiocyanate group, a nitro group, an alkoxy group, an aryloxy group, a silyl group, a silyloxy group, a heterocyclic oxy group, an acyloxy group, a carbamoyloxy group, an alkoxycarbonyloxy group, an aryloxycarbonyloxy group, a primary, secondary, or tertiary amino group (including an anilino group), an alkylthio group, an arylthio group, a heterocyclic thio group, an alkyl or an arylsulfinyl group, an alkyl or an arylsulfonyl group, an acyl group, an aryloxycarbonyl group, an alkoxycarbonyl group, an aryl or a heterocyclic azo group, an imide group, a phosphino group, a phosphinyl group, a phosphinyloxy group, a phosphinylamino group, a phosphono group, a carboxy group, a phosphoric acid group, a sulfonic acid group, a hydroxy group, a thiol group, an acylamino group, a carbamoyl group, a ureido group, a boronic acid group, and a group formed by combining these groups.

Among these, the substituent is preferably the alkyl group, the alkoxy group, the cyano group, or the isothiocyanate group, which may include an oxygen atom, a nitrogen atom, or a sulfur atom. The alkyl group may include an oxygen atom, a nitrogen atom, or a sulfur atom. For example, the alkyl group and the alkoxy group may include —O—, —S—, —CO—, —CS—, —CO—O—, —CO—NR¹⁰—, —NR¹⁰—, or a group obtained by combining these at a carbon-carbon atom or a terminal. R¹⁰ represents a hydrogen atom or an alkyl group.

The alkyl group and the alkoxy group may include a plurality of —O—'s, —S—'s, —CO—'s, —CS—'s, —CO—O—'s, —CO—NR¹⁰—'s, —NR¹⁰—'s, or groups obtained by combining these groups.

The number of carbon atoms in the alkyl group and the alkoxy group is not particularly limited, and is preferably 1 to 30, more preferably 1 to 25, and still more preferably 3 to 25.

As the dichroic coloring agent used in the present invention, a compound represented by Formula (Y) is also preferable.

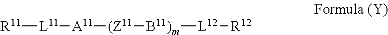

In Formula (Y),

R¹¹ and R¹² each independently represent an alkyl group in which —CH₂— may be substituted with —O— or —CO—O—, a cyano group, a halogen atom, —N═C═S, or —N═C═Se.

It should be noted that at least one of R¹¹ or R¹² represents an alkyl group having an asymmetric carbon atom, and the total number of asymmetric carbon atoms contained in R¹¹ and R¹² is 2 or more.

L¹¹ and L¹² each independently represent a single bond, —O—, —CO—, —CO—O—, —O—CO—O—, —NR¹³—, or —CH═CH—, and O may be substituted with S.

R¹³ represents an alkyl group which may have a substituent.

A¹¹ and B¹¹ each independently represent an aromatic ring group which may have a substituent or an aliphatic ring group which may have a substituent.

Examples of the aromatic ring group represented by A¹¹ and B¹¹ include the divalent aromatic hydrocarbon ring group or the divalent aromatic heterocyclic group described for A and B in Formula (X), and in a case where a plurality of B¹¹'s are present, B¹¹'s may be the same as or different from each other.

Z¹¹ represents a single bond, —O—, —CO—, —CO—O—, —O—CO—O—, —CR^{Z}═CR^{Z}—, —C≡C—, —N═N—, —CR^{Z}═CR^{Z}—CR^{Z}═CR^{Z}—, —C≡C—C≡C—, —CR^{Z}═CR^{Z}—CO—, or —CR^{Z}═CR^{Z}—CO—O—, O may be substituted with S, and in a case where a plurality of Z¹¹'s are present, Z¹¹'s may be the same as or different from each other.

R^{Z}'s each independently represent a hydrogen atom or a fluorine atom.

m represents an integer of 1 to 4.

As the dichroic coloring agent used in the present invention, the compound described in “Dichroic Dyes for Liquid Crystal Display” (A. V. Ivashchenko, CRC Press, 1994) can also be used. In addition, methine-based coloring agents such as cyanine, oxonol, and merocyanine can also be used.

The total content of the dichroic coloring agent in the present composition is 30% by mass or more with respect to the total mass of the present composition. Furthermore, in a case where the present composition includes only one dichroic coloring agent as the dichroic coloring agent, the total content of the dichroic coloring agent corresponds to a content of the one dichroic coloring agent with respect to the total mass of the present composition. In addition, in a case where the present composition includes two or more dichroic coloring agents, the total content of the dichroic coloring agent corresponds to the total amount of the two or more dichroic coloring agents.

As described later, in the liquid crystal composition layer consisting of the present composition, a state where the refractive index anisotropy with respect to radio waves is high can be obtained. The details of the reason are not clear, but it is presumed that by increasing the total content of the dichroic coloring agent in the liquid crystal composition layer, the interaction between the dichroic coloring agents increases, and thus the degree of alignment order of the absorption axis due to the absorption skeleton in the dichroic coloring agent can be increased, and as a result, the absorption anisotropy of the dichroic coloring agent affects the increase in the refractive index anisotropy at a wavelength longer than the absorption wavelength.

Furthermore, from the viewpoint that the effect of the present invention is more excellent, the total content of the dichroic coloring agent in the present composition is preferably 50% by mass or more, more preferably 80% by mass or more, and still more preferably 90% by mass or more with respect to the total mass of the present composition. The upper limit thereof is not particularly limited, and examples thereof include 100% by mass or less.

### <Other Components>

The present composition may include components other than the dichroic coloring agent.

Examples of such other components include a liquid crystal compound.

The liquid crystal compound which may be used in combination with the dichroic coloring agent is preferably a liquid crystal compound having a skeleton having a high Δn. Examples of the skeleton having a high Δn include a skeleton which has a plurality of rings selected from an aromatic hydrocarbon ring and an aromatic heterocyclic ring, and has a triple bond and/or a double bond as a linking group. As the linking group, trans, di-trans, vinylene, or butadiene is preferable, and a plurality of these linking groups may be contained in a single molecule.

In addition, it is preferable that the liquid crystal compound has an electron-donating substituent or an electron-accepting substituent at a terminal. Examples of the electron-donating substituent include an alkoxy group, a thioalkoxy group, and an alkylamino group. Examples of the electron-accepting group include a cyano group, a nitro group, an isocyanate group, an isothiocyanate group, a cyanovinylene group, and a dicyanovinylene group.

These compounds do not need to be visible and transparent, and Δn tends to be higher as the absorption wavelength extends into the visible light region. The maximum absorption wavelength (λmax) of these compounds is preferably 320 nm or more, more preferably 350 nm or more, and still more preferably 380 nm or more.

Furthermore, it is preferable that the present composition does not substantially include a solvent. The phrase “substantially not including a solvent” means that the content of the solvent is 5% by mass or less, and preferably 1% by mass or less with respect to the total mass of the present composition.

### <Liquid Crystal Composition for Radio Wave Control Element>

The present composition is a composition exhibiting liquid crystallinity. For example, in a case where the present composition includes a liquid crystalline dichroic coloring agent, it can exhibit liquid crystallinity.

Among these, from the viewpoint that the effect of the present invention is more excellent, it is preferable that the present composition exhibits a nematic phase in the entire range of 10° C. to 50° C.

In addition, it is preferable that the present composition exhibits a nematic phase at any temperature between 50° C. and 150° C., and exhibits a glassy state or smectic liquid crystallinity at any temperature lower than 50° C.

### <Radio Wave Control Element>

The present composition can be applied to a radio wave control element. The radio wave control element acts on radio waves. Examples of the radio waves include radio waves having frequencies of 0.007 to 0.3 THz. The radio waves RW in this frequency band are also referred to as high-frequency radio waves (centimeter waves, millimeter waves, or terahertz waves), or the like, and are capable of performing high-capacity wireless communication, but have high straightness.

An example of the radio wave control element may be a radio wave control element having a first electrode, a liquid crystal composition layer consisting of the present composition, and a second electrode in this order. In the radio wave control element, by applying a voltage between the first electrode and the second electrode, the alignment state of the dichroic coloring agents included in the liquid crystal composition layer is controlled, and the refractive index anisotropy of the liquid crystal composition layer is adjusted, whereby the traveling directions of the radio waves can be adjusted.

In the liquid crystal composition layer consisting of the present composition, the alignment state of the dichroic coloring agents can be changed by a voltage. In particular, in a case where the dichroic coloring agent exhibits liquid crystallinity, the characteristics are likely to be exhibited.

In the liquid crystal composition layer consisting of the present composition, a state where a large refractive index anisotropy is exhibited can be obtained by controlling the alignment state of the dichroic coloring agents. Usually, the response speed in the radio wave control element depends on the film thickness of the liquid crystal composition layer. In the liquid crystal composition layer consisting of the present composition, since a state exhibiting high refractive index anisotropy can be obtained, the film thickness of the liquid crystal composition layer can be reduced, and thus the response speed can be improved. Therefore, the switching of the reflection direction or the like of the incident radio waves can be performed in a short time.

Furthermore, in the radio wave control element including a liquid crystal composition layer consisting of the present composition, by setting the above-described integrating accumulate absorbance Q to a predetermined value or more, an effect of reducing noise of a sensor using visible light or infrared light can also be obtained. More specifically, in a case where the integrating accumulate absorbance Q is large, visible light or infrared light incident on the radio wave control element is absorbed by the liquid crystal composition layer and thus does not turn noise light, making it possible to provide a radio wave control element that is less likely to produce noise light. That is, it is possible to realize an electromagnetic wave control element that does not cause unnecessary reflection and scattering due to the radio wave control element and is less likely to give noise, with respect to signal detection by a sensor of visible light and infrared light that is also used with an antenna.

In addition, from the viewpoint of decoration, there is an effect of making the electrode used in the radio wave control element inconspicuous, which is desirable.

Hereinafter, specific examples of the radio wave control element will be described with reference to the drawings.

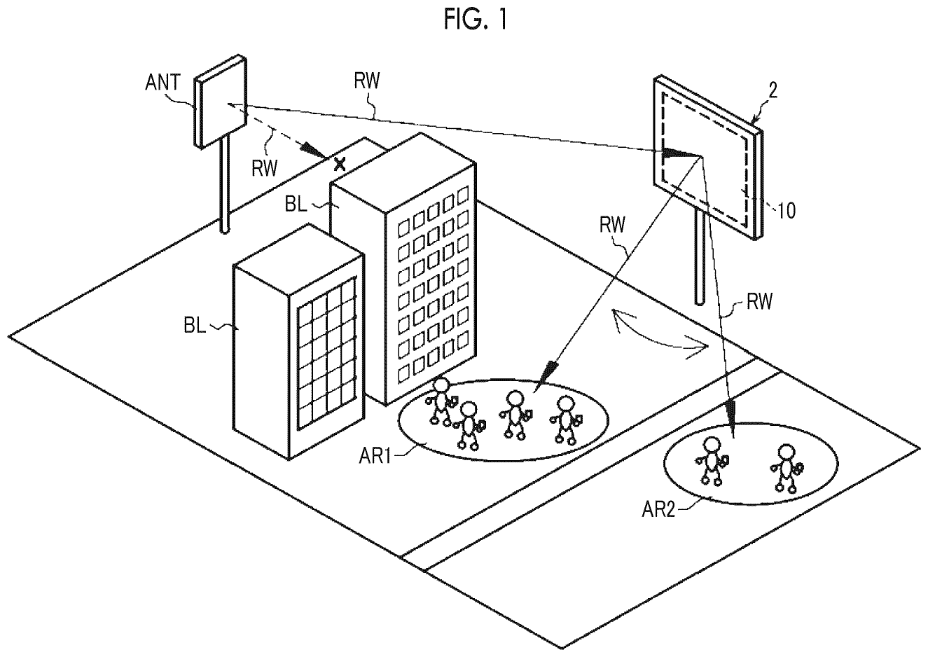

A radio wave control element 10A according to the present disclosed technology is used in a radio wave reflection device 2 shown in FIG. 1. The radio wave reflection device 2 is capable of reflecting radio waves RW having high straightness, which are radiated from an antenna ANT disposed behind the building BL, toward an area AR1 in front of the building BL which is in the shadow as viewed from the antenna ANT.

In addition, the radio wave reflection device 2 can change the reflection directions of the radio waves RW in different directions of the plurality of areas AR1 and the area AR2. For example, there are cases where the area where many users utilizing wireless communication are present changes depending on the time slot of the day, such as the area AR1 where many users are present in the daytime slot and the area AR2 where many users are present in the night time slot. In such a case, the radio wave reflection device 2 is capable of changing the area to which the radio wave RW is supplied by changing the reflection directions of the radio waves RW according to the time slot.

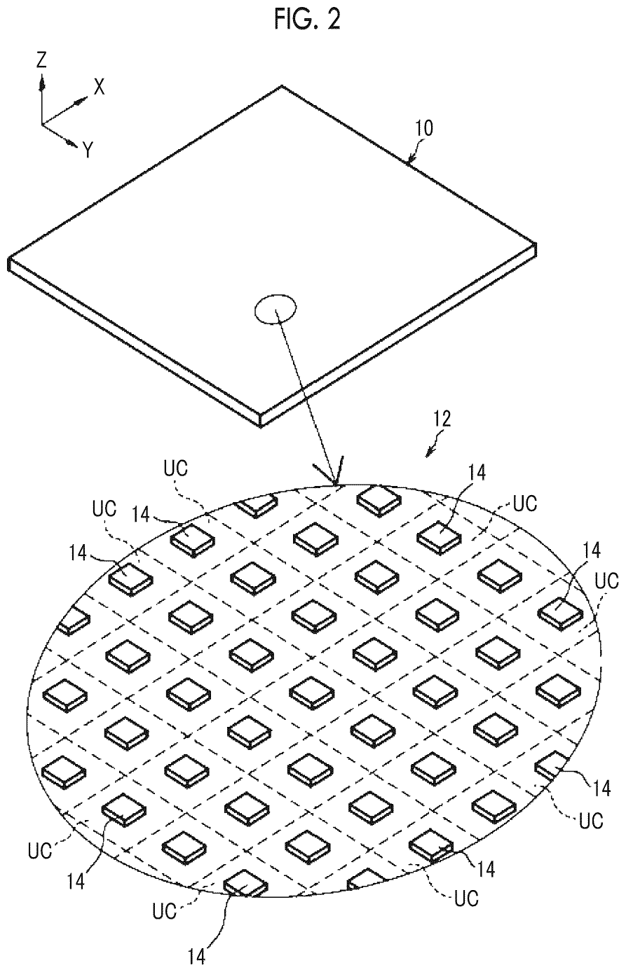

As shown in FIG. 2, the radio wave control element 10A has a metasurface structure 12, and is a reflective radio wave control element that reflects the traveling directions of the radio waves RW in desired directions.

The metasurface structure 12 is a structure that uses a metamaterial. The metamaterial refers to an artificial substance exhibiting a property not found in a substance in nature, such as a negative refractive index with respect to radio waves. The radio wave control element 10A has a configuration in which a plurality of unit cells UC are two-dimensionally arranged, and a two-dimensional plane formed by the arrangement of the plurality of unit cells UC serves as a reflecting surface of the radio wave RW. Each unit cell UC includes the microstructure 14 as a metamaterial, and constitutes a minimum unit capable of actively changing the phase of the radio wave RW on the reflecting surface. The microstructure 14 is made of a metal, for example. The microstructure 14 has a size of the order of the wavelength or less of the incident radio wave RW and functions as a resonator that resonates due to interaction with the incident radio wave RW. The microstructure 14 can be considered to be, for example, electrically equivalent to a resonance circuit in which a coil and a capacitor are connected in series and an alternating current is resonated. The phase of the incident radio wave RW changes due to the resonance action of the microstructure 14. Furthermore, by actively changing the resonance condition of the microstructure 14 by various methods, it is also possible to control the delay amount of the phase of the radio wave RW.

The radio wave control element 10A mainly acts on radio waves RW having a frequency of 0.007 to 0.3 THz.

In the radio wave control element 10A, the metasurface structure 12 is configured to act on the radio waves RW having a frequency of 0.007 to 0.3 THz. The wavelength of the radio wave RW having a frequency of 0.007 to 0.3 THz is 0.07 to 3 mm, and the size of the microstructure 14 constituting the metasurface structure 12 is, for example, on the order of about ½ of the wavelength. By setting the size of the microstructure 14 to be equal to or less than the wavelength of the radio wave RW, the microstructure 14 resonates with the radio wave RW transmitted therethrough and functions as a phase modulation element that modulates the phase of the radio waves RW.

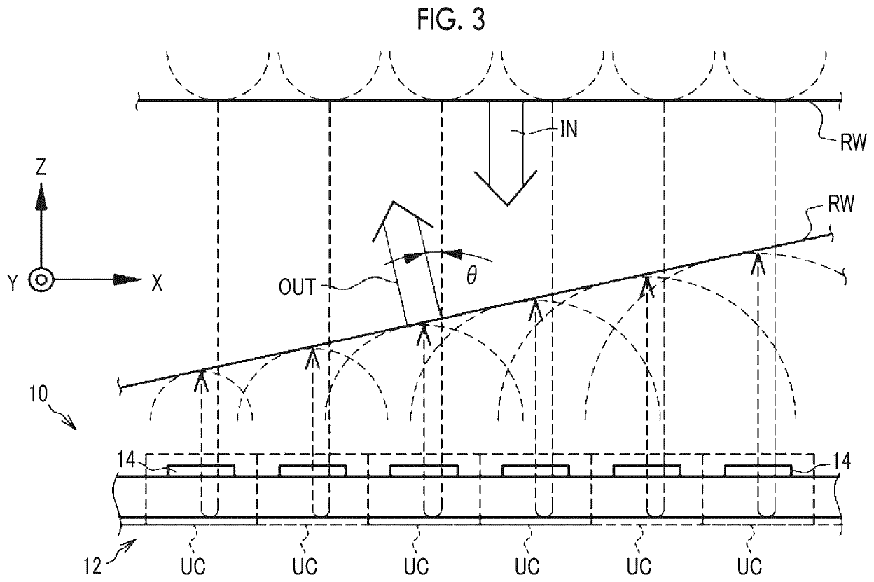

In FIG. 3, as exemplified by the incidence direction IN and the emission direction OUT, an overall traveling direction of the radio wave RW can be considered to be a normal direction with respect to a straight line connecting wavefronts of the plurality of radio waves RW. Furthermore, in the radio wave control element 10A, for example, it is considered that the delay amount of the phase of the radio wave RW incident on and reflected from each of the plurality of unit cells UC arranged in one dimension gradually increases from the unit cell UC in the right direction to the unit cell UC in the left direction. Then, even in a case where a straight line connecting the wavefronts of the individual incident radio waves RW is parallel to the reflecting surface, a straight line connecting the wavefronts of the individual radio waves RW reflected by each unit cell UC is inclined with respect to the reflecting surface. That is, the emission direction OUT, which is a traveling direction of the radio wave RW emitted from the reflecting surface, is changed by an angle θ with respect to the incidence direction IN of the radio wave RW. In this way, the traveling direction of the radio wave RW can be controlled by performing the phase modulation, that is, controlling the delay amount of the phase for each unit cell UC.

As a result, in a normal reflector, the traveling direction of the radio wave RW can only be changed toward the direction of specular reflection, while in the radio wave reflection device 2, it is possible to change the traveling direction of the radio wave RW toward directions other than specular reflection by using the metasurface structure 12. In addition, by actively changing the delay amount of the phase in each unit cell UC, it is possible to actively change the traveling direction of the radio wave RW.

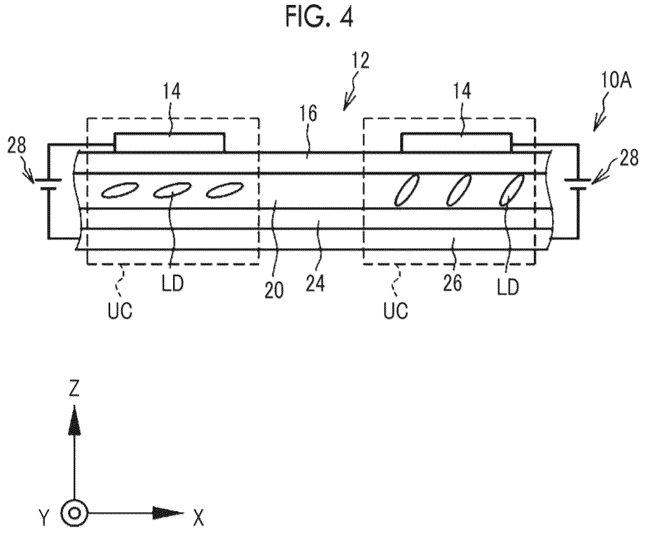

As conceptually shown in FIG. 4 as an example, the radio wave control element 10A uses the liquid crystal composition layer 20 as an element that actively changes the resonance conditions of the microstructure 14 of the metasurface structure 12. The radio wave control element 10A has a first electrode layer 26, a liquid crystal composition layer 20, and a metasurface structure 12 in this order from the lower side in the drawing. The liquid crystal composition layer 20 is provided on the support 24. Furthermore, the first electrode layer 26 is provided to entirely cover the surface of the support 24 on the side opposite to the liquid crystal composition layer 20. The liquid crystal composition layer 20 includes a dichroic coloring agent (liquid crystalline dichroic coloring agent LD) exhibiting liquid crystallinity.

Each unit cell UC is configured to include the microstructure 14, the liquid crystal composition layer 20, and the first electrode layer 26. Among these, the microstructure 14 is individually provided for each unit cell UC. The support 16, the liquid crystal composition layer 20, the support 24, and the first electrode layer 26 other than the above-described layers are not independently formed for each unit cell UC, and regions corresponding to a plurality of unit cells UC are integrally formed.

In the radio wave control element 10A, the first electrode layer 26 and the support 24, and the liquid crystal composition layer 20 and the support 16 are bonded using a bonding agent (pressure sensitive adhesive or adhesive) as necessary. The bonding method is not limited, and various known methods in which radio waves targeted by the radio wave control element 10A can be transmitted, such as a method using an optical clear adhesive (OCA) through which radio waves targeted by the radio wave control element 10A can be transmitted, can be used.

The microstructure 14 is formed of a conductive material as an example, and also serves as an electrode that constitutes the first electrode layer 26 and the electrode pair.

In addition, a power supply 28 for applying a voltage between the microstructure 14 and the first electrode layer 26 is connected to each of the microstructures 14. Therefore, it is possible to control the magnitude of the voltage applied to each unit cell UC. The first electrode layer 26 is a common electrode common to each unit cell UC, and the microstructure 14 of each unit cell UC functions as an individual electrode. The first electrode layer 26 that functions as a common electrode is an example of a “first electrode” according to the present disclosed technology, and the individual electrode that is also used by the microstructure 14 is an example of a “second electrode”. The microstructure 14 as the second electrode and the first electrode layer 26 as the first electrode are an example of an “electrode pair for applying a voltage”.

The radio wave control element 10A is a reflective type, and the first electrode layer 26 also serves as a reflective layer that reflects the radio wave RW.

In the liquid crystal composition layer 20, the alignment state (hereinafter also referred to as an alignment pattern) of the liquid crystalline dichroic coloring agents changes upon the application of a voltage. The arrangement direction of the microstructure 14 of each unit cell UC is a direction (X direction or Y direction in the drawing) orthogonal to the thickness direction (Z direction in the drawing) of the liquid crystal composition layer 20. Here, the microstructure 14 and the first electrode layer 26 are disposed on both sides of the liquid crystal composition layer 20 in the thickness direction. By supplying electric power from the power supply 28, a voltage is applied between the microstructure 14 of each unit cell UC and the first electrode layer 26. By applying a voltage, an electric field is generated in the thickness direction of the liquid crystal composition layer 20, and the alignment state of the liquid crystalline dichroic coloring agents LD of each unit cell UC changes. In addition, the alignment state of the liquid crystalline dichroic coloring agents LD in each unit cell UC can be adjusted by adjusting a voltage applied to each unit cell UC.

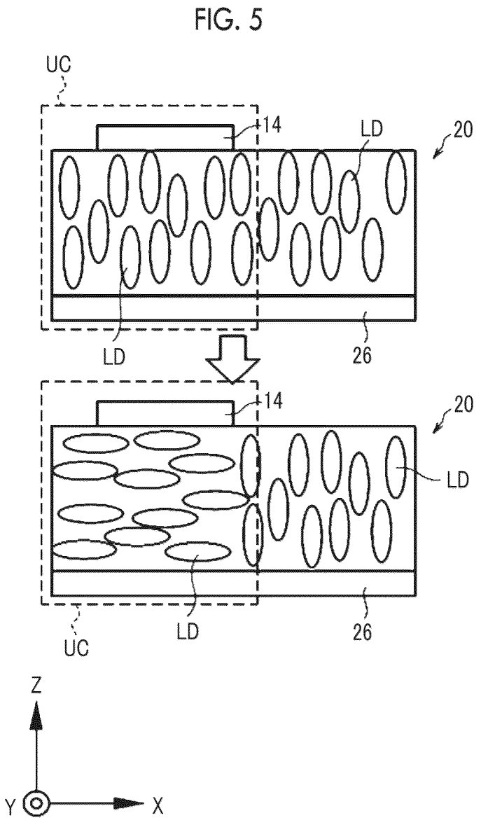

As shown in FIG. 5, the liquid crystalline dichroic coloring agent LD has a substantially elliptical shape having a major axis and a minor axis in a cross section. As an example, in a state where no voltage is applied between the microstructure 14 that functions as an electrode pair and the first electrode layer 26, an electric field is not generated in the liquid crystal composition layer 20. In this state, as conceptually shown in an upper part of FIG. 5, the liquid crystalline dichroic coloring agents LD are aligned in a posture in which a major axis is parallel to a thickness direction of the liquid crystal composition layer 20. In the following description, this alignment state is also referred to as a “vertical alignment”.

In a case where a voltage is applied between the microstructure 14 and the first electrode layer 26 from this state, an electric field is generated in the liquid crystal composition layer 20, and the alignment state of the liquid crystalline dichroic coloring agents LD changes. Specifically, as conceptually shown in the lower part of FIG. 5, the alignment state of the liquid crystalline dichroic coloring agents LD in the region corresponding to the microstructure 14 changes depending on a magnitude of the applied voltage, and is tilted with respect to the thickness direction of the liquid crystal composition layer 20. In the example shown in the lower part of FIG. 5, a state where the tilt angle of the liquid crystalline dichroic coloring agent LD is the maximum is shown. In a state where the tilt angle is the maximum, the liquid crystalline dichroic coloring agents LD are aligned in a posture in which the major axis is parallel to a direction orthogonal to the thickness direction of the liquid crystal composition layer 20. In the following description, the alignment state where the tilt angle is the maximum is also referred to as “horizontal alignment”.

As the tilt of the liquid crystalline dichroic coloring agent LD increases, that is, the angle of the major axis of the liquid crystalline dichroic coloring agent LD is closer to the main surface direction (the X direction or the Y direction in FIG. 5) of the liquid crystal composition layer 20, the refractive index of the liquid crystal composition layer 20 increases. On the contrary, as the tilt of the liquid crystalline dichroic coloring agent LD decreases, that is, the angle of the major axis of the liquid crystalline dichroic coloring agent LD is closer to the thickness direction (Z direction in the drawing) of the liquid crystal composition layer 20, the refractive index of the liquid crystal composition layer 20 decreases. Due to such a change in the refractive index of the liquid crystal composition layer 20 of each unit cell UC, the resonance condition of the microstructure 14 changes and the delay amount of the phase of the incident radio wave RW changes. In the present example, the delay amount of the phase of the lower unit cell UC of FIG. 5 is larger than that of the upper unit cell UC of FIG. 5.

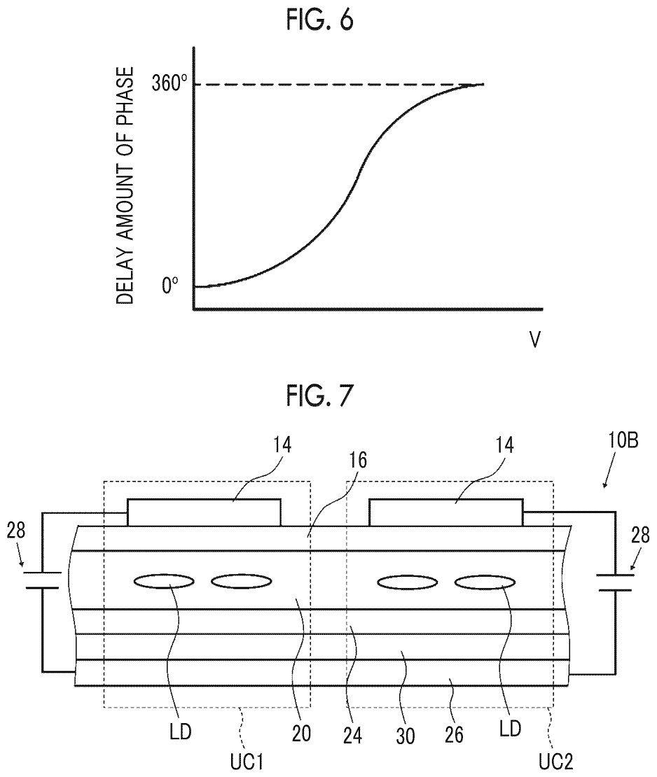

That is, in the liquid crystal composition layer 20 positioned around the microstructure 14 of each unit cell UC, in a case where the alignment state of the liquid crystalline dichroic coloring agents LD changes, the refractive index of the liquid crystal composition layer 20 with respect to the radio wave RW transmitted through each unit cell UC changes. Furthermore, since the refractive index and the dielectric constant have a positive correlation, the resonance condition of the microstructure 14 that functions as a resonator changes due to the change in the refractive index of the liquid crystal composition layer 20. The change in the resonance condition of the microstructure 14 appears as a change in the delay amount of the phase of the radio wave RW. Therefore, the delay amount of the phase of the radio wave RW can be changed by changing the refractive index of the liquid crystal composition layer 20. In addition, the change in the refractive index of the liquid crystal composition layer 20 also causes a change in the delay amount of the phase of the radio wave RW. Since the refractive index of the liquid crystal composition layer 20 of each unit cell UC changes depending on the voltage V applied to each unit cell UC, the relationship between the voltage V and the delay amount of the phase of the radio wave RW is as shown in FIG. 6 as an example.

As shown in FIG. 3, in a case where the radio wave RW is incident on the radio wave control element 10A from the microstructure 14 side, the radio wave RW is transmitted through the microstructure 14 and the liquid crystal composition layer 20 in this order. Furthermore, the radio wave RW is reflected from the first electrode layer 26 that serves as a reflective layer, and again transmitted through the liquid crystal composition layer 20 and the microstructure 14 in this order, thereby being emitted from the radio wave control element 10A. The radio wave RW is reflected through such incidence and emission paths. In the incidence and emission paths, for the radio wave RW transmitted through each unit cell UC, the phase modulation due to the resonance of the microstructure 14 and the phase modulation due to the transmission through the liquid crystal composition layer 20 occur. More specifically, in each unit cell UC, the resonance condition of the microstructure 14 is determined according to the refractive index of the liquid crystal composition layer 20, and the phase modulation of the radio wave RW occurs due to the resonance under the condition. In addition, the phase modulation of the radio wave RW depending on a magnitude of the refractive index of the liquid crystal composition layer 20 also occurs.

By controlling the delay amount of the phase of the radio wave RW for each unit cell UC through the applied voltage V based on the relationship shown in FIG. 6, the reflection direction of the radio wave RW reflected by the radio wave control element 10A is controlled.

As shown in FIG. 3, in a normal reflector, the traveling direction of the radio wave RW can only be changed toward the direction of specular reflection, while in the radio wave control element 10A, it is possible to change the traveling direction of the radio wave RW toward directions other than specular reflection by using the metasurface structure 12. In addition, by actively changing the delay amount of the phase in each unit cell UC, it is possible to actively change the traveling direction of the radio wave RW.

Furthermore, for the control of the traveling direction of the radio wave RW emitted from the radio wave control element 10A, various examples can be considered, in addition to the control of the reflected radio wave RW to travel in one direction as a whole as in the example shown in FIG. 3. For example, the radio wave RW emitted from the radio wave control element 10A may converge toward a single focal point, or conversely, may be diverged from the focal point. The control of the traveling direction of the emitted radio wave RW can be performed by adjusting the voltage applied to each unit cell UC to adjust the delay amount of the phase of the radio wave RW of each unit cell UC.

For example, in a case where there are a plurality of unit cells UC arranged in one direction as shown in FIG. 3, it is considered that the delay amount of the phase of the central unit cell UC is increased and the delay amount of the phase is decreased toward both sides. In this case, the wavefronts of the radio waves RW transmitted through each unit cell UC are connected to each other to have a V-shape, and therefore, the radio waves RW to be emitted can converge. In addition, on the contrary, it is considered that the delay amount of the phase of the central unit cell UC is decreased and the delay amount of the phase is increased toward both sides. In this case, the wavefronts of the radio waves RW transmitted through each unit cell UC are connected to each other to have a chevron shape (reverse V-shape), and therefore, the radio waves RW to be emitted can be diverged. The degrees of convergence and divergence can also be adjusted by controlling the delay amount of the phase of the radio wave RW transmitted through each unit cell UC through adjustment of the magnitude of the applied voltage.

The metasurface structure 12 is formed by two-dimensionally arranging the microstructures 14, which are metamaterials, on the support 16 in the same manner as a known metasurface structure. In the metasurface structure 12 in the example shown in the drawing, the microstructures 14 are two-dimensionally arranged at regular intervals in the X direction and the Y direction, which are orthogonal to each other as shown in FIG. 2. In addition, in the metasurface structure 12, the microstructures 14 are all the same, for example.

The support 16 is not limited, and various known sheet-like materials can be used as long as the support 16 can support the microstructures 14 and the radio waves RW having a frequency of 0.007 to 0.3 THz targeted by the radio wave control element 10A can be transmitted. Examples of the support 16 include a metal substrate having an oxide insulating layer, such as a silicon substrate having silicon oxide, a support consisting of an oxide such as silicon oxide, a support consisting of a semiconductor such as germanium and chalcogenide glass, a polyacrylic resin film such as polymethyl methacrylate, a cellulose resin film such as cellulose triacetate, a cycloolefin polymer-based film (for example, product name “ARTON”, manufactured by JSR Corporation, product name “ZEONOR”, manufactured by Zeon Corporation), a polyethylene terephthalate (PET) film, a polycarbonate film, a resin film such as a polyvinyl chloride film, and a glass plate.

The thickness of the support 16 is not limited, and may be any thickness as long as the support 16 can support the microstructures 14, a sufficient transmittance can be obtained for the radio waves RW having a frequency of 0.007 to 0.3 THz, and a sufficient strength can be obtained depending on the use of the radio wave control element 10A, and the like. The thickness of the support 16 is appropriately set according to the material forming the support 16 to satisfy such conditions.

Furthermore, in the radio wave control element 10A according to the present disclosed technology, the support 16 is not in an essential configuration in the metasurface structure 12, and the support 16 may not be provided. For example, the metasurface structure 12 may be formed by directly arranging the microstructures 14 on a surface of the liquid crystal composition layer 20, if possible.

As described above, the metasurface structure 12 is formed by two-dimensionally arranging the microstructures 14, which are the metamaterials, on a plane to be spaced, and more specifically, is configured by an arrangement of unit cells UC, each of which is a unit of one microstructure 14 and a space around the microstructure 14.

In the radio wave control element 10A according to the present disclosed technology, the form of the metasurface structure is basically the same as that of the known metasurface structure. Accordingly, in the radio wave control element 10A according to the present disclosed technology, various known metasurface structures can be used.

That is, in the present disclosed technology, the shape and the material forming the microstructure 14, the arrangement of the microstructures 14, the pitch which is the interval of the microstructures 14, and the like are not limited. In addition, the metasurface structure 12 may be designed by a known method according to the wavelength of the radio wave RW to be controlled and the target reflection characteristics (for example, the range of a controllable reflection direction) of the radio wave control element 10A. As an example, the amplitude and the phase of the radio waves RW reflected by the microstructure 14 to be used may be calculated using commercially available simulation software, and the arrangement of the microstructures 14 may be set to obtain a desired distribution of the phase modulation amount. In a case where the liquid crystal composition layer 20 is used as in the present example, the phase modulation is generated by the refractive index and further by an interaction between the refractive index and the microstructure 14, and the phase modulation amount is determined by the resonance characteristics of the microstructure 14 that change depending on the refractive index.

The radio wave control element 10A according to the present disclosed technology controls radio waves RW having a frequency of 0.007 to 0.3 THz. Accordingly, in the metasurface structure 12, the microstructure 14 is selected such that a desired phase difference is imparted to the radio wave RW having the frequency, and further, the arrangement of the microstructures, and the like are set. Specifically, in a case where the radio waves RW having a frequency of 0.007 to 0.3 THz are a target to be controlled, the wavelength range of the radio waves RW is about 0.07 to 3 mm, and thus the size of the microstructures 14 is also selected to be equal to or smaller than the wavelength range.

The number of the microstructures 14 contained in one unit cell UC is basically one, but the present disclosed technology is not limited thereto. That is, in the radio wave control element according to the present disclosed technology, one unit cell UC may have a plurality of the microstructures 14, as necessary, depending on the reflection characteristics, the size, the forming material, and the shape of the microstructure 14, the size of the unit cell UC, and the like. In this case, one unit cell UC may have different microstructures 14. It should be noted that since the unit cell UC is the minimum unit capable of actively changing the phase of the radio wave RW, even in a case where one unit cell UC has a plurality of the microstructures 14, the amount of the phase modulation is determined for each unit cell UC.

In addition, the material forming the microstructure 14 is not limited, and various materials that are used as a microstructure in known metasurface structures can be used. Examples of the material forming the microstructure 14 include a metal and a dielectric. In a case of the metal, preferred examples of the material include copper, gold, and silver from the viewpoint of low optical loss. In addition, as the material forming the microstructure 14, a composite body consisting of metal particles and a binder, and an oxide semiconductor can also be used. On the other hand, in a case of the dielectric, silicon, titanium oxide, and germanium are preferably exemplified in consideration of the views that, for example, the refractive index is large and the phase modulation amount can be increased. Furthermore, as shown in FIG. 4, in a case where the microstructure 14 also serves as an electrode forming an electrode pair together with the first electrode layer 26, the microstructure 14 is formed of a conductor.

Similarly, the shape of the microstructure 14 is also not limited, and various shapes used as the microstructure in a known metasurface structure can be used. Examples of the shape include a cross-like three-dimensional structure in which cuboids intersect with each other, a cuboid shape, a cylindrical shape, a V-like three-dimensional structure in which cuboids are connected to end parts as described in JP2018-046395A, an H-like three-dimensional structure such as H-steel, and a substantially C-like three-dimensional structure such as a C-channel. In addition, as shown in JP2018-046395A, various shapes where an angle between two cuboids is adjusted can be used as the V-like three-dimensional structure and the cross-like three-dimensional structure. In addition to those, the three-dimensional structure having a bottom surface shape as shown in Figure. 5 of “Appl. Sci. 2018, 8(9), 1689; https://doi.org/10.3390/app8091689”, or the like can also be used.

In the metasurface structure 12, the same kind of such microstructures 14 may be used or a plurality of kinds of the microstructures 14 may be used in combination. In addition, the same microstructures 14 may be arranged in the same orientation or may be arranged in different orientations in the XY plane. Moreover, there may exist a mixture of the ones in the same orientation and the ones in different orientations. However, in the radio wave control element 10A according to the present disclosed technology, it is preferable that only one kind of the microstructures 14 are used and all the microstructures 14 are arranged in the same orientation.

In addition, as shown in FIG. 3, in a preferred aspect of the metasurface structure 12, the same microstructures 14, all having the same structure, are two-dimensionally arranged at regular intervals in the X direction and the Y direction, which are orthogonal to each other. However, the present disclosed technology is not limited thereto. A plurality of kinds of the microstructures may be used in combination as described above, and the arrangement interval and the arrangement of the microstructures 14 may also be different in the plane direction of the support 16. It should be noted that in consideration of the controllability of the reflection directions of the radio waves RW in a case where a voltage is applied to the liquid crystal composition layer 20, it is preferable that the metasurface structure 12 is formed of the same microstructures 14. Furthermore, in the metasurface structure 12, the intervals between the microstructures 14 are more preferably equal intervals, and are still more preferably equal intervals in both the X direction and the Y direction, which are orthogonal to each other.

The liquid crystal composition layer 20 is a layer formed by aligning the liquid crystalline dichroic coloring agents LD in a preset state, and as described above, the alignment state of the liquid crystalline dichroic coloring agents LD changes by applying a voltage.

In the liquid crystal composition layer 20 shown in FIG. 5, the liquid crystalline dichroic coloring agents LD are vertically aligned in a state where no voltage is applied. In a case where a voltage is applied to the liquid crystal composition layer 20, the liquid crystalline dichroic coloring agents LD are aligned to be tilted with respect to the thickness direction depending on the voltage, and reach horizontal alignment at the maximum. Furthermore, in the radio wave control element 10A, the change in the alignment of the liquid crystalline dichroic coloring agents LD is not limited to a change from the vertical alignment to the horizontal alignment or vice versa, may be a change from a state of being tilted with respect to the thickness direction to the horizontal alignment or the vertical alignment, may be a change from the horizontal alignment or the vertical alignment to a state of being tilted with respect to the thickness direction, or may be a change in the angle from a state of being tilted with respect to the thickness direction to a state of being tilted with respect to the thickness direction.

In addition, the liquid crystal composition layer 20 may be formed on a surface of the alignment film described later by a known method.

In the radio wave control element 10A, the liquid crystal composition layer 20 is formed on the support 24. The support 24 is basically the same as the above-described support 16.

Here, the support 24 on which the liquid crystal composition layer 20 is formed may further have an alignment film for aligning the liquid crystalline dichroic coloring agents LD in a predetermined state on a surface of the above-described support 16 used as a main body, on which the liquid crystal composition layer 20 of the main body is formed. As the alignment film, various known films can be used. Examples of the alignment film include a rubbing-treated film consisting of an organic compound such as a polymer, an obliquely vapor-deposited film with an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, and methyl stearate. In addition, as the alignment film, a so-called photo-alignment film obtained by irradiating a photo-alignable material with polarized light or non-polarized light can be used. These alignment films may be formed by a known method depending on a material forming the main body.

The surface of the support 24 forming the liquid crystal composition layer 20 on a side opposite to the liquid crystal composition layer 20 is entirely covered with the first electrode layer 26. The first electrode layer 26 is an electrode that changes the alignment of the liquid crystalline dichroic coloring agents LD in the liquid crystal composition layer 20, and also acts as a reflective layer that reflects the radio waves RW having a frequency of 0.007 to 0.3 THz incident from the metasurface structure 12 side, as described above.

The first electrode layer 26 is not limited, and a sheet-like material consisting of various known materials can be used as long as it has sufficient conductivity and can reflect the radio waves RW.

Examples of the first electrode layer 26 include metal layers such as copper, aluminum, gold, and silver, inorganic conductive materials such as indium tin oxide (ITO), organic conductive materials such as polythiophene typified by poly(3,4-ethylenedioxythiophene) (PEDOT), and graphene. The inorganic conductive material, the organic conductive material, the graphene, and the like are transparent to visible light, but act as a reflective layer with respect to the radio waves having the frequency.

The thickness of the first electrode layer 26 is not limited, and the thickness with which radio waves as a target can be reflected with a required reflectivity may be appropriately set depending on a material forming the first electrode layer 26.

As described above, the radio wave control element 10A according to the present disclosed technology is a reflective radio wave control element having the metasurface structure 12 and the liquid crystal composition layer 20. In the radio wave control element 10A, by supplying power to each of the microstructures 14 to change the alignment state of the liquid crystalline dichroic coloring agents LD in the corresponding region of the liquid crystal composition layer 20, regions having different refractive indices are formed in each unit cell UC, and the radio waves RW are thus reflected in desired directions. In addition, the reflection directions of the incident radio waves RW can be switched by changing the power supplied to each of the microstructures 14, that is, the voltage applied to the liquid crystal composition layer 20.

In the radio wave control element 10A according to the present disclosed technology, the refractive index anisotropy Δn of the liquid crystal composition layer 20 with respect to the radio waves is not particularly limited, but is preferably large. Here, in the reflective radio wave control element 10A of the present example, the refractive index anisotropy Δn of the liquid crystal composition layer 20 with respect to the radio wave of 100 GHz is preferably 0.35 or more. From the viewpoint that the liquid crystal composition layer 20 can be made thin, and thus the switching of the reflection direction of the radio wave RW can be performed more quickly, it is preferable to set the refractive index anisotropy Δn of the liquid crystal composition layer 20 with respect to the radio wave of 100 GHz to 0.35 or more.

In addition, the thickness of the liquid crystal composition layer 20 is not limited, and the thickness for imparting a phase difference required for the radio waves RW may be appropriately set depending on a material forming the liquid crystal composition layer 20. Here, as described above, since the radio wave control element 10A according to the present disclosed technology is composed of the present composition in which the liquid crystal composition layer 20 includes a predetermined amount of a dichroic coloring agent, the liquid crystal composition layer 20 can be made thin. In consideration of this viewpoint, the thickness of the liquid crystal composition layer 20 is preferably 200 μm or less, more preferably 150 μm or less, and still more preferably 100 μm or less. From the viewpoint that the switching of the reflection direction of the radio wave RW can be performed more quickly, it is preferable to set the thickness of the liquid crystal composition layer 20 to 200 μm or less.

In addition, an aspect in which a temperature adjusting member that adjusts the temperature of the liquid crystal composition layer is provided is exemplified as another example of the radio wave control element. In such an aspect, the alignment state of the dichroic coloring agents in the liquid crystal composition layer can be fixed. Hereinafter, this aspect will be described in detail.

A radio wave control element 10B shown in FIG. 7 has a first electrode layer 26, a liquid crystal composition layer 20, and a metasurface structure 12 in this order from the lower side in the drawing. The liquid crystal composition layer 20 is provided on the support 24. Furthermore, the first electrode layer 26 is provided to entirely cover the surface of the support 24 on the side opposite to the liquid crystal composition layer 20. Furthermore, a temperature adjusting member 30 is provided between the support 24 and the first electrode layer 26.

A radio wave control element 10B shown in FIG. 7 has the same configuration as the radio wave control element 10A shown in FIG. 4, except that the radio wave control element 10B has the temperature adjusting member 30.

Furthermore, in the liquid crystal composition layer 20 shown in FIG. 7, in a state where no voltage is applied, the liquid crystalline dichroic coloring agents LD are horizontally aligned, and as the voltage to be applied is increased, the liquid crystalline dichroic coloring agents LD are aligned in a direction in which the liquid crystalline dichroic coloring agents LD are vertically aligned.

The temperature adjusting member 30 is not particularly limited as long as it is a member that adjusts the temperature of the liquid crystal composition layer 20. The temperature adjusting member 30 is also not limited in a location where it is disposed as long as it can effectively adjust the temperature of the liquid crystal composition layer 20. In addition, the temperature adjusting member 30 may have a heating device that increases the temperature of the liquid crystal composition layer 20, a cooling device that decreases the temperature of the liquid crystal composition layer 20, and the like.

The procedure for fixing the alignment state of the liquid crystalline dichroic coloring agents LD in the liquid crystal composition layer 20 using the radio wave control element 10B is as follows. Furthermore, as the liquid crystalline dichroic coloring agent LD included in the liquid crystal composition layer 20, a compound exhibiting liquid crystallinity in a case where the liquid crystal composition layer 20 is subjected to a heating treatment by the temperature adjusting member 30 is used. Specifically, it is preferable to use the present composition which exhibits a nematic phase at any temperature between 50° C. and 150° C., and exhibits a glassy state or smectic phase at any temperature lower than 50° C., as described above.

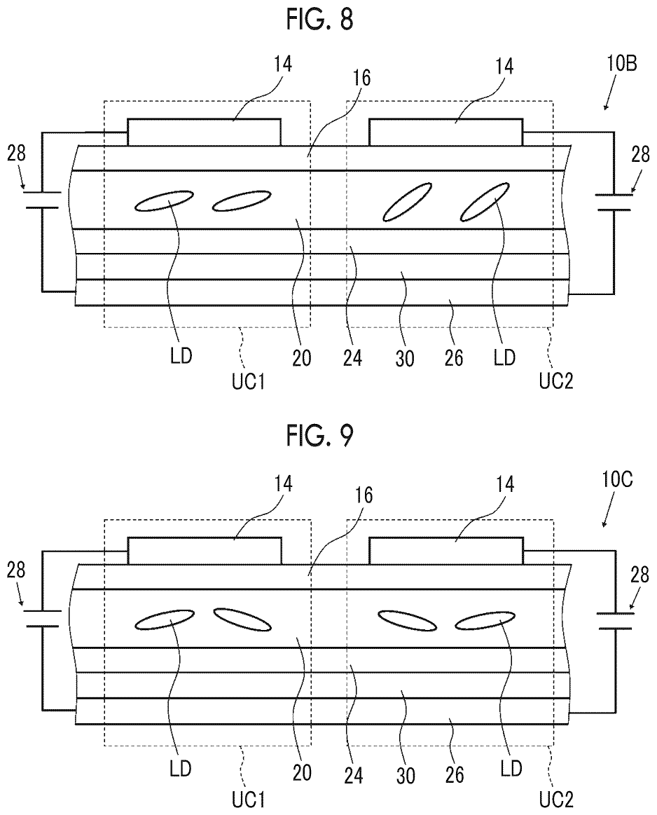

First, the liquid crystal composition layer 20 is heated by the temperature adjusting member 30 in the radio wave control element 10B, and transferred to a liquid crystal phase. Next, while maintaining the heating treatment, a voltage is applied between the first electrode layer 26 and the microstructure 14 to control the alignment direction of the liquid crystalline dichroic coloring agents LD. In this case, as shown in FIG. 8, the alignment state of the liquid crystalline dichroic coloring agents LD may be different by changing the voltages applied to the first unit cell UC1 and the second unit cell UC2. Thereafter, in a case where the heating treatment and the application treatment are stopped, the temperature drops to at or below the transition temperature of the liquid crystal phase, and the alignment state of the liquid crystalline dichroic coloring agents in the state of FIG. 8 is fixed. That is, the state where the liquid crystalline dichroic coloring agents are aligned can be maintained even in a case where no voltage is applied.

In addition, in the radio wave control element, a state with higher aligning properties can be created depending on the type of dichroic coloring agent to be used.

For example, in a case where the liquid crystalline dichroic coloring agent exhibits a nematic phase and also a higher-order liquid crystal phase such as a smectic phase, the higher-order liquid crystal phase can be fixed by rapidly cooling the radio wave control element.

More specifically, the radio wave control element 10C shown in FIG. 9 has the same configuration as the radio wave control element 10B shown in FIG. 7. It should be noted that in the radio wave control element 10C, the liquid crystalline dichroic coloring agent LD exhibits a nematic phase while exhibiting a smectic phase. In addition, in the liquid crystal composition layer 20 shown in FIG. 9, in a state where no voltage is applied, the liquid crystalline dichroic coloring agents LD are horizontally aligned, and as the voltage to be applied is increased, the liquid crystalline dichroic coloring agents LD are aligned in a direction in which the liquid crystalline dichroic coloring agents LD are vertically aligned.

In such a radio wave control element 10C, as shown in FIG. 9, the liquid crystal composition layer 20 is heated by the temperature adjusting member 30 to align the liquid crystalline dichroic coloring agents LD, thereby exhibiting a nematic phase. Furthermore, in FIG. 9, this corresponds to an aspect in which no voltage is applied between the first electrode layer 26 and the microstructure 14, resulting in the liquid crystalline dichroic coloring agents LD being horizontally aligned. As shown in FIG. 9, the liquid crystalline dichroic coloring agents LD are horizontally aligned, but the alignment degree of the nematic phase itself is not high. Thus, the alignment direction of the liquid crystalline dichroic coloring agents LD is partially disturbed.

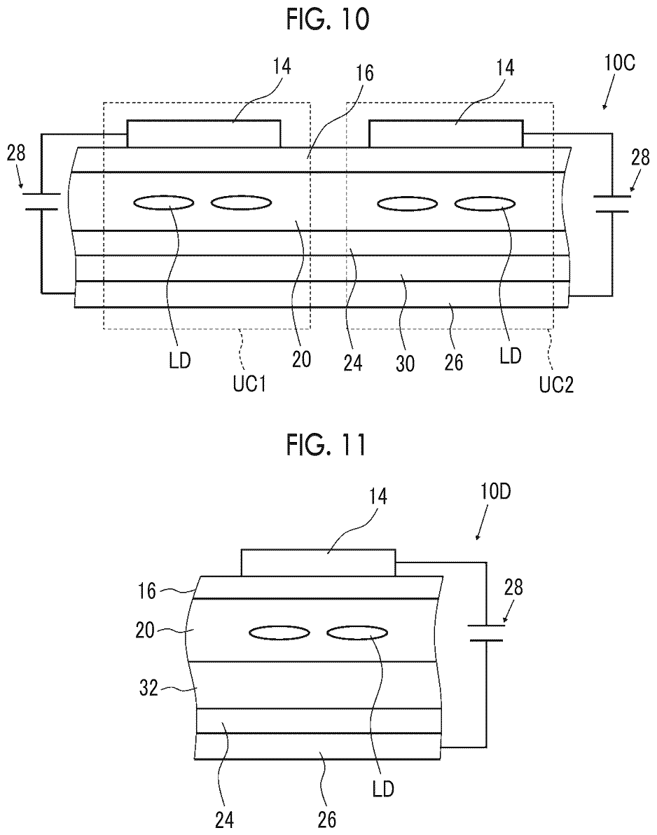

Next, in a case where the heating treatment of the temperature adjusting member 30 is stopped and the liquid crystal composition layer 20 is rapidly cooled, the liquid crystalline dichroic coloring agents LD can be fixed in a state of exhibiting a smectic phase. Specifically, as shown in FIG. 10, the aligning properties of the liquid crystalline dichroic coloring agents LD are further improved. That is, by carrying out the rapid cooling treatment, the liquid crystalline dichroic coloring agents can be fixed in a state where the alignment degree is higher.

In addition, the radio wave control element may have a layer having no occurrence of a change in refractive index due to a voltage between the first electrode and the second electrode, or may have a gap between one of the first electrode and the second electrode and the liquid crystal composition layer.

More specifically, a radio wave control element 10D shown in FIG. 11 has a first electrode layer 26, a dielectric layer 32, a liquid crystal composition layer 20, and a metasurface structure 12 in this order from the lower side in the drawing.

The radio wave control element 10D shown in FIG. 11 has the same configuration as the radio wave control element 10A shown in FIG. 4, except that the radio wave control element 10D has the dielectric layer 32. Furthermore, in the liquid crystal composition layer 20 shown in FIG. 10, in a state where no voltage is applied, the liquid crystalline dichroic coloring agents LD are horizontally aligned, and as the voltage to be applied is increased, the liquid crystalline dichroic coloring agents LD are aligned in a direction in which the liquid crystalline dichroic coloring agents LD are vertically aligned.

The dielectric layer 32 is a layer having no occurrence of a change in refractive index due to a voltage.

The material constituting the dielectric layer 32 is not particularly limited as long as sufficient transmittance to the radio waves RW can be obtained. Examples thereof include semiconductors such as silicon, silicon oxide, germanium, and chalcogenide glass, polyacrylic resins such as polymethyl methacrylate, cellulose-based resins such as cellulose triacetate, cycloolefin polymers, resins such as polyethylene terephthalate (PET), polycarbonate, and polyvinyl chloride, and glass.

In addition, an alignment film for aligning the above-described liquid crystalline dichroic coloring agents LD in a predetermined state may be used as the dielectric layer 32.

The thickness of the dielectric layer 32 is not particularly limited, and is preferably about the same as the thickness of the liquid crystal composition layer 20. The difference between the thickness of the dielectric layer 32 and the thickness of the liquid crystal composition layer 20 is preferably 100 μm or less, and more preferably 50 μm or less.

As in the radio wave control element 10D, in a case where the dielectric layer 32 is disposed between the first electrode layer 26 and the microstructure 14, a distance between the electrodes can be increased. By adopting such a configuration, it is possible to suppress the loss of the radio waves while maintaining a high response speed of the radio wave control element 10D. At this time, a location of the electrode for driving that applies a voltage to the liquid crystal composition layer is not particularly limited, but the electrode may be the first electrode layer 26 and the microstructure 14. In addition, in order to efficiently apply a voltage to the liquid crystal composition layer, an electrode may be provided between the dielectric layer 32 and the liquid crystal composition layer. In this case, a high-resistance electrode may be used so that the influence on radio waves is small. Moreover, the electrodes may be positioned to sandwich the liquid crystal composition layer in the horizontal direction in order to drive the liquid crystal composition layer with a transverse electric field.

In addition, the dielectric constant of the material constituting the dielectric layer 32 with respect to the applied voltage is not particularly limited. In a case where the liquid crystal composition layer and the dielectric layer are arranged in series between the facing surface electrodes as in the case where the first electrode layer 26 and the microstructure 14 of the radio wave control element 10D are electrodes, a higher dielectric constant of the dielectric layer is preferable since the electric field to the liquid crystal composition layer can be efficiently increased. Moreover, in a case where the electrodes are positioned to sandwich the liquid crystal composition layer in the horizontal direction in order to drive the liquid crystal composition layer with a transverse electric field, a lower dielectric constant of the dielectric layer is preferable since the electric field of the liquid crystal composition layer can be efficiently increased. In addition, the dielectric layer may be patterned in the in-plane direction or the thickness direction, whereby the radio wave control amount can be adjusted by adjusting the in-plane average effective value of the refractive index or the effective value distribution in the element.

In addition, the radio wave control element may have a light shielding layer that shields at least a part of light in a wavelength range of 250 to 1,000 nm.

The position where the light shielding layer is disposed in the radio wave control element is not particularly limited, but it is preferable that the light shielding layer is disposed on a side of the liquid crystal composition layer on which external light is incident. In a case where the radio wave control element has a light shielding layer, light that can be absorbed by the dichroic coloring agent can be prevented from reaching the dichroic coloring agent, and as a result, the decomposition of the dichroic coloring agent can be suppressed.

### Examples

Hereinafter, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the scope of the present invention should not be restrictively interpreted by the following Examples.

### <Dichroic Coloring Agent>

The following compounds 1-1 to 1-7 and 2-1 to 2-6 were prepared as dichroic coloring agents.

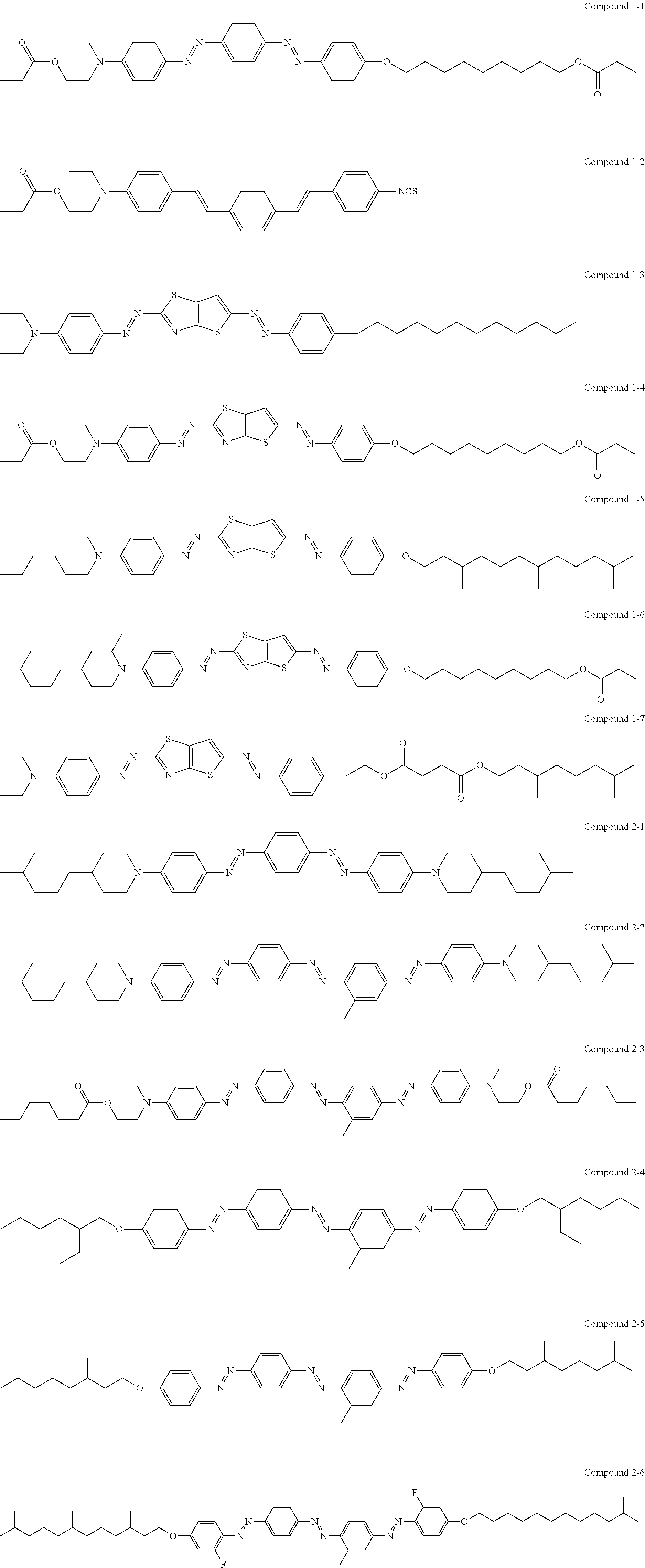

In addition, as the liquid crystal compound used in Examples and Comparative Examples, the following compound 3 and liquid crystal compound A (liquid crystal A) (RDP-94990 manufactured by DIC Corporation) were prepared.

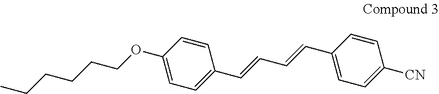 [SMILES: CCCCCCOc1ccc(/C=C/C=C/c2ccc(C#N)cc2)cc1]

Furthermore, integrating accumulate absorbances Q of the compounds 1-1 to 1-7, 2-1 to 2-6, 3, and the liquid crystal A, which were measured by the same procedure as that for the integrating accumulate absorbance Q of the present composition, are shown in Table 1. Integrating accumulate absorbances Q of the compounds 1-1 to 1-7, 2-1 to 2-6, 3, and the liquid crystal A are the ones measured by the same procedure as that for the integrating accumulate absorbance Q of the present composition, except that D in Expression (1) described above was changed to a mass concentration (g·L⁻¹) in a chloroform solution of any of the compounds 1-1 to 1-7, 2-1 to 2-6, 3, and the liquid crystal A.

TABLE 1

| | Integrating accumulate absorbance Q |
|---|---|
| | (L · g⁻¹ · cm⁻¹) |
| Compound 1-1 | 6,300 |
| Compound 1-2 | 9,700 |
| Compound 1-3 | 17,100 |
| Compound 1-4 | 14,500 |
| Compound 1-5 | 15,800 |
| Compound 1-6 | 14,900 |
| Compound 1-7 | 14,700 |
| Compound 2-1 | 10,600 |
| Compound 2-2 | 12,700 |
| Compound 2-3 | 12,100 |
| Compound 2-4 | 9,600 |
| Compound 2-5 | 8,500 |
| Compound 2-6 | 6,900 |
| Compound 3 | 6,700 |
| Liquid crystal A | 120 |

Next, the compounds 1-1 to 1-7, 2-1 to 2-6, 3, and the liquid crystal A were mixed to have the compositions shown in Table 2 described later, thereby preparing compositions.

### <Evaluations>

### (Liquid Crystallinity)

The composition was heated and observed with a polarizing microscope with a hot stage, and a difference (TB−TA) between a transition temperature (TA) from a crystal phase to a nematic phase (liquid crystal phase) and a transition temperature (TB) from the nematic phase (liquid crystal phase) to an isotropic phase was evaluated. The composition in which the difference (TB−TA) was 50° C. or more was denoted as A, the composition in which the difference (TB−TA) was less than 50° C. was denoted as B, and the composition in which the liquid crystal phase was not exhibited was denoted as C.

### (Refractive Index Anisotropy (Δn))

The refractive index anisotropy Δn at radio waves of 100 GHz and 30 GHz was measured by the method disclosed in Applied Optics, Vol. 44, No. 7, p. 1150 (2005).

For the refractive index anisotropy Δn (100 GHz), a variable short-circuit waveguide was filled with the composition and the dichroic coloring agents were aligned in the composition. A radio wave of 100 GHz was input to the waveguide, and an amplitude ratio of a reflected wave to an incident wave was measured. The measurement was performed by changing the orientation of the static magnetic field and the length of the short-circuit tube, and the refractive indices ne and no were determined. The refractive index anisotropy (Δn (100 GHz)) was calculated from ne−no. Those with Δn (100 GHz) of 0.4 or more were denoted as A, those with Δn (100 GHz) of 0.35 or more and less than 0.4 were denoted as B, and those with Δn (100 GHz) of less than 0.35 were denoted as C. Similarly, using an input radio wave of 30 GHz, with regard to the measured refractive index anisotropy Δn (30 GHz), the following classification was used: was classified as follows: those with Δn (30 GHz) of 0.4 or more were denoted as A, those with Δn (30 GHz) between 0.35 and less than 0.4 were denoted as B, and those with Δn (30 GHz) of less than 0.35 were denoted as C.

In Table 2, the column of “First component (%)”, the column of “Second component (%)”, and the column of “Third component (%)” indicate the type of each component used and the mass content (% by mass) of each component with respect to the total mass of the composition.

In Table 2, “Integrating accumulate absorbance Q” is a measured value of the above-described integrating accumulate absorbance Q.

Furthermore, the compositions used in Examples 1 to 11 exhibited a nematic phase at any temperature between 50° C. and 150° C., and exhibited a glassy state or smectic phase at any temperature lower than 50° C.

TABLE 2

| | | | | | | Integrating | | | |
|---|---|---|---|---|---|---|---|---|---|
| | | | | | | accumulate | | | |
| | First | Second | Third | Fourth | Fifth | absorbance | | Δn | Δn |
| | component | component | component | component | component | Q | Liquid | (100 | (30 |
| | (%) | (%) | (%) | (%) | (%) | (L · g⁻¹ · cm⁻¹) | crystallinity | GHz) | GHz) |
| Example 1 | Compound | Compound | — | — | — | 11,700 | A | A | A |
| | 1-1 | 1-3 | | | | | | | |
| | (50) | (50) | | | | | | | |
| Example 2 | Compound | Compound | — | — | — | 15,800 | A | A | A |
| | 1-3 | 1-4 | | | | | | | |
| | (50) | (50) | | | | | | | |
| Example 3 | Compound | Compound | Compound | — | — | 11,300 | A | A | A |
| | 1-1 | 1-2 | 1-3 | | | | | | |
| | (40) | (20) | (40) | | | | | | |
| Example 4 | Compound | Compound | Compound | — | — | 14,580 | A | A | A |
| | 1-2 | 1-3 | 1-4 | | | | | | |
| | (20) | (40) | (40) | | | | | | |
| Example 5 | Compound | — | — | — | — | 14,500 | B | — | A |
| | 1-4 | | | | | | | | |
| | (100) | | | | | | | | |
| Example 6 | Compound | Compound | Compound | — | — | 14,950 | A | — | A |
| | 1-3 | 1-5 | 2-2 | | | | | | |
| | (30) | (30) | (40) | | | | | | |
| Example 7 | Compound | Compound | Compound | Compound | — | 12,450 | A | — | A |
| | 1-6 | 1-7 | 2-1 | 2-4 | | | | | |
| | (25) | (25) | (25) | (25) | | | | | |
| Example 8 | Compound | Compound | Compound | — | — | 10,120 | A | — | B |
| | 2-3 | 2-5 | 3 | | | | | | |
| | (50) | (40) | (10) | | | | | | |
| Example 9 | Compound | Compound | Compound | Compound | Compound | 11,030 | A | — | B |
| | 1-5 | 1-7 | 2-4 | 2-6 | 3 | | | | |
| | (20) | (20) | (30) | (20) | (10) | | | | |
| Example 10 | Compound | Compound | Compound | Compound | — | 10,160 | A | — | B |
| | 1-5 | 1-7 | 2-6 | 3 | | | | | |
| | (20) | (20) | (20) | (40) | | | | | |
| Example 11 | Compound | Compound | — | — | — | 10,340 | A | — | B |
| | 1-3 | 3 | | | | | | | |
| | (35) | (65) | | | | | | | |
| Comparative | Compound | Liquid | — | — | — | 430 | A | C | C |
| Example 1 | 1-1 | crystal A | | | | | | | |
| | (5) | (95) | | | | | | | |

As shown in Table 2, it was confirmed that the present composition exhibited a desired effect.

### EXPLANATION OF REFERENCES

2: radio wave reflection device
10A, 10B, 10C, 10D: radio wave control element
12: metasurface structure
14: microstructure
16, 24: support
20: liquid crystal layer
26: first electrode layer
28: power supply
30: temperature adjusting member
32: dielectric layer
ANT: antenna
AR1, AR2: area
BL: building
LD: liquid crystalline dichroic coloring agent
RW: radio wave
UC: unit cell

What is claimed is:

1. A liquid crystal composition for a radio wave control element, the liquid crystal composition comprising:
at least one dichroic coloring agent,
wherein a total content of the dichroic coloring agent is 30% by mass or more with respect to a total mass of the liquid crystal composition for a radio wave control element, and
an integrating accumulate absorbance Q represented by Expression (1) in a wavelength range of 350 to 1,000 nm in an absorption spectrum of a chloroform solution of the liquid crystal composition for a radio wave control element is 10,000 L·g⁻¹·cm⁻¹ or more,
$$Q = \frac{1}{D \cdot L} {\int }_{350}^{1000} Abs ( λ ) d λ \qquad Expression ( 1 )$$
in Expression (1), Q represents an integrating accumulate absorbance (L·g⁻¹·cm⁻¹), D represents a mass concentration (g·L⁻¹) of the liquid crystal composition for a radio wave control element in the chloroform solution, L represents an optical path length (cm) of a cell used for measuring the absorption spectrum, and Abs (λ) represents an absorbance at a wavelength λ (nm).

2. The liquid crystal composition for a radio wave control element according to claim 1,
wherein the liquid crystal composition for a radio wave control element includes two or more dichroic coloring agents.

3. The liquid crystal composition for a radio wave control element according to claim 1,
wherein the dichroic coloring agent is a compound represented by Formula (X), 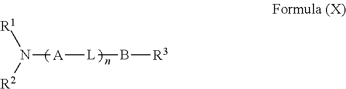
in Formula (X), R¹ and R² each independently represent a linear or branched hydrocarbon group having 1 to 10 carbon atoms, and the hydrocarbon group may include an oxygen atom, a nitrogen atom, or a sulfur atom,
R¹ and R² may be bonded to each other to form a ring,
A and B each independently represent a divalent aromatic ring group,
L represents a single bond, —CR═CR—, —C≡C—, —CR═N—, or —N═N—,
R's each independently represent a hydrogen atom, a halogen atom, or an alkyl group having 1 to 6 carbon atoms,
n represents an integer of 1 to 3, and in a case where n is 2 or 3, a plurality of A's and L′'s may be the same as or different from each other, and
R³ represents a hydrogen atom or a substituent.

4. The liquid crystal composition for a radio wave control element according to claim 1,
wherein the liquid crystal composition for a radio wave control element exhibits a nematic phase in an entire range of 10° C. to 50° C.

5. The liquid crystal composition for a radio wave control element according to claim 1,
wherein the liquid crystal composition for a radio wave control element exhibits a nematic phase at any temperature between 50° C. and 150° C., and exhibits a glassy state or smectic phase at any temperature lower than 50° C.

6. A radio wave control element comprising, in the following order:
a first electrode;
a liquid crystal composition layer consisting of the liquid crystal composition for a radio wave control element according to claim 1; and
a second electrode.

7. The radio wave control element according to claim 6,
wherein the radio wave control element has a metasurface structure obtained by arranging a plurality of microstructures, and
the microstructure constitutes at least one of the first electrode or the second electrode.

8. The radio wave control element according to claim 6, further comprising:
a temperature adjusting member that adjusts a temperature of the liquid crystal composition layer.

9. The radio wave control element according to claim 6,
wherein the radio wave control element has a layer having no occurrence of a change in refractive index due to a voltage between the first electrode and the second electrode, or a gap between one of the first electrode and the second electrode and the liquid crystal composition layer.

10. The radio wave control element according to claim 6, further comprising:
a light shielding layer that shields at least a part of light in a wavelength range of 250 to 1,000 nm.

11. The liquid crystal composition for a radio wave control element according to claim 2,
wherein the dichroic coloring agent is a compound represented by Formula (X), 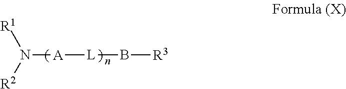
in Formula (X), R¹ and R² each independently represent a linear or branched hydrocarbon group having 1 to 10 carbon atoms, and the hydrocarbon group may include an oxygen atom, a nitrogen atom, or a sulfur atom,
R¹ and R² may be bonded to each other to form a ring,
A and B each independently represent a divalent aromatic ring group,
L represents a single bond, —CR═CR—, —C≡C—, —CR═N—, or —N═N—,
R's each independently represent a hydrogen atom, a halogen atom, or an alkyl group having 1 to 6 carbon atoms,
n represents an integer of 1 to 3, and in a case where n is 2 or 3, a plurality of A's and L′'s may be the same as or different from each other, and
R³ represents a hydrogen atom or a substituent.

12. The liquid crystal composition for a radio wave control element according to claim 2,
wherein the liquid crystal composition for a radio wave control element exhibits a nematic phase in an entire range of 10° C. to 50° C.

13. The liquid crystal composition for a radio wave control element according to claim 2,
wherein the liquid crystal composition for a radio wave control element exhibits a nematic phase at any temperature between 50° C. and 150° C., and exhibits a glassy state or smectic phase at any temperature lower than 50° C.

14. A radio wave control element comprising, in the following order:
a first electrode;
a liquid crystal composition layer consisting of the liquid crystal composition for a radio wave control element according to claim 2; and
a second electrode.

15. The radio wave control element according to claim 14,
wherein the radio wave control element has a metasurface structure obtained by arranging a plurality of microstructures, and
the microstructure constitutes at least one of the first electrode or the second electrode.

16. The radio wave control element according to claim 7, further comprising:
a temperature adjusting member that adjusts a temperature of the liquid crystal composition layer.

17. The radio wave control element according to claim 7,
wherein the radio wave control element has a layer having no occurrence of a change in refractive index due to a voltage between the first electrode and the second electrode, or a gap between one of the first electrode and the second electrode and the liquid crystal composition layer.

18. The radio wave control element according to claim 7, further comprising:
a light shielding layer that shields at least a part of light in a wavelength range of 250 to 1,000 nm.

19. The liquid crystal composition for a radio wave control element according to claim 3,
wherein the liquid crystal composition for a radio wave control element exhibits a nematic phase in an entire range of 10° C. to 50° C.

20. The liquid crystal composition for a radio wave control element according to claim 3,
wherein the liquid crystal composition for a radio wave control element exhibits a nematic phase at any temperature between 50° C. and 150° C., and exhibits a glassy state or smectic phase at any temperature lower than 50° C.
